(19) United States
(12) Patent Application Publication
(10) Pub. No.: US 2009/0215507 A1
(43) Pub. Date: Aug. 27, 2009

(54) A CELLULAR PHONE OF SLIDE-DOWN OPENING AND CLOSING TYPE

(75) Inventor: Kwang Duck Park, Gyeonggi-do (KR)

Correspondence Address: HARNESS, DICKEY, & PIERCE, P.L.C, 7700 Bonhomme, Suite 400, ST. LOUIS, MO, 63105, US

(73) Assignee: Laird Technologies MAP CO., LTD, Bucheon-si, Gyeonggi-do (KR)

(21) Appl. No.: 12/162,526

(22) PCT Filed: Jun. 29, 2007
(86) PCT No.: PCT/KR2007/003169

§ 371 Date: Nov. 13, 2008

(30) Foreign Application Priority Data
Jul. 5, 2006 (KR) 10-2006-0063167

(51) Int. Cl. H04M 1/00

(52) U.S. Cl. 455/575.4

(57) ABSTRACT

Disclosed herein is a slide-down type portable terminal. The terminal includes a main body and a sub-body capable of sliding on the main body. Either one of the main body and the sub body is provided with a first slider groove formed along the sliding direction. The first slider groove has a straight portion and a curved-down portion consecutively formed from the straight portion. The other one of the main body and the sub body is provided with a first slider protrusion slidably engaging the slide groove, such that the sub body drops down while slidably opening with respect to the main body, or vice versa.

### TECHNICAL FIELD

The present invention relates to a slider type portable terminal. More particularly, the invention relates to a slider type portable terminal, in which the whole thickness of the terminal can be minimized when it is opened, thereby improving the user's wearing comfort and the structural stability of the terminal.

### BACKGROUND ART

Portable terminals can be categorized into a bar-type, a flip type, a folder type and the like.

Along with wide variations in the cellular phone design, recently a slider-type portable terminal has been developed, where a sub-body equipped with a display slidably operates on a main body having a keypad.

FIG. 1 shows an example of conventional slider-type portable terminals.

In the slider-type terminal 1, a sub-body 2 is configured to slidably open and close with respect to a main body 3 in the arrow direction.

This slider type terminal 1 takes advantage of a folder type terminal. That is, the sub-body 2 shields the keypad of the main body 3 when closed, to thereby avoid mal-operations or accidental operations. The receiver is installed in the sub-body and the transmitter is installed in the main body so as to secure a sufficient distance between the receiver and transmitter.

In addition, the display mounted on the sub-body 2 faces forwards all the times. Thus, a single display can be used to reduce the production cost and the users can view the display even when the sub-body 2 is closed.

In case of this slider-type terminal 1, however, the sub-body 2 and main body 3 are designed to linearly move against each other when they are being opened and closed. Thus, the conventional slider-type terminal 1 maintains the combined thickness of the main body 3 and sub-body 2 all the time during operations.

Therefore, when it is opened, the conventional slider-type terminal 1 comes to have a larger thickness, as compared with other types of portable terminals, thereby degrading the user's wearing comfort.

### DISCLOSURE OF INVENTION

### Technical Problem

The present invention has been made in order to solve at least part of the problems in the art. It is an object of the invention to provide a slider type portable terminal, in which the whole thickness of the terminal can be minimized when it is opened, thereby improving the user's wearing comfort and the structural stability of the terminal.

### Technical Solution

In order to accomplish the above objects, according to one aspect of the invention, there is provided a slide-down type portable terminal comprising a main body, and a sub-body capable of sliding on the main body. Either one of the main body and the sub body is provided with a first slider groove formed along the sliding direction. The first slider groove has a straight portion and a curved-down portion consecutively formed from the straight portion. The other one of the main body and the sub body is provided with a first slider protrusion slidably engaging the slide groove, such that the sub body drops down while slidably opening with respect to the main body, or vice versa.

In an embodiment, a first slider plate and a second slider plate are fixed to the sub-body, and a first lever and a second lever are rotatably installed in the main body. The first lever allows the first slider plate to slide while the sub-body is in the straight portion and rotates by down-movement of the first slider plate during the curved-down portion. The second lever allows the second slider plate to slide while the sub-body is in the straight portion and rotates by down-movement of the second slider plate during the curved-down portion.

In an embodiment, a second slider groove is formed in either one of the first slider plate and the first lever and in either one of the second slider plate and the second lever. A slider protrusion is formed in the other one of the first slider plate and the first lever and in the other one of the second slider plate and the second lever. The slider protrusion is engaged with the second slider groove.

In an embodiment, a resiliently protruding means is installed in at least one of the first and second levers, and the first slider plate or the second slider plate or both is formed with a groove with which the resiliently protruding means is engaged.

In an embodiment, the resiliently protruding means includes a slider cam horizontally moving and having a first bevel face, a lift cam having a second bevel face face-contacting with the first bevel face and vertically moving to be engaged with and released from the groove, and a compression spring for urging the slider cam towards the lift cam.

In an embodiment, a clutch member is installed in the main body. The clutch member generates a resistant force against rotation of the first or second lever or both at the initial state and at the later state generating a force urging the rotation.

### Advantageous Effects

According to the above-mentioned invention, when the sub-body is opened from the main body, the combined thickness of the terminal can be maximally reduced to thereby improve user s wearing comfort and the structural stability of the terminal.

### BRIEF DESCRIPTION OF THE DRAWINGS

Further objects and advantages of the invention can be more fully understood from the following detailed description taken in conjunction with the accompanying drawings in which:

FIG. 1 is a perspective view showing a conventional slider-type portable terminal;

FIG. 2 is a perspective view showing a portable terminal according to an embodiment of the invention;

FIG. 3 is an exploded perspective view of the portable terminal of FIG. 2;

FIGS. 4 to 7 are exploded perspective view for major components in the portable terminal of FIG. 3;

FIGS. 8 and 9 are perspective views showing operations of the portable terminal of FIG. 2;

FIG. 10 is a transversal cross-section showing the portable terminal of FIG. 2 when the sub-body is closed;

FIG. 11 is a vertical cross-section showing the portable terminal of FIG. 2 when the sub-body is closed;

FIG. 12 is a transversal cross-section showing the portable terminal of FIG. 10 when the sub-body is being opened;

FIG. 13 is a vertical cross-section showing the portable terminal of FIG. 12 when the sub-body is being opened;

FIG. 14 is a transversal cross-section showing portable terminal of FIG. 12 when the sub-body is completely opened; and

FIG. 15 is a vertical cross-section showing the portable terminal of FIG. 13 when the sub-body is completed opened.

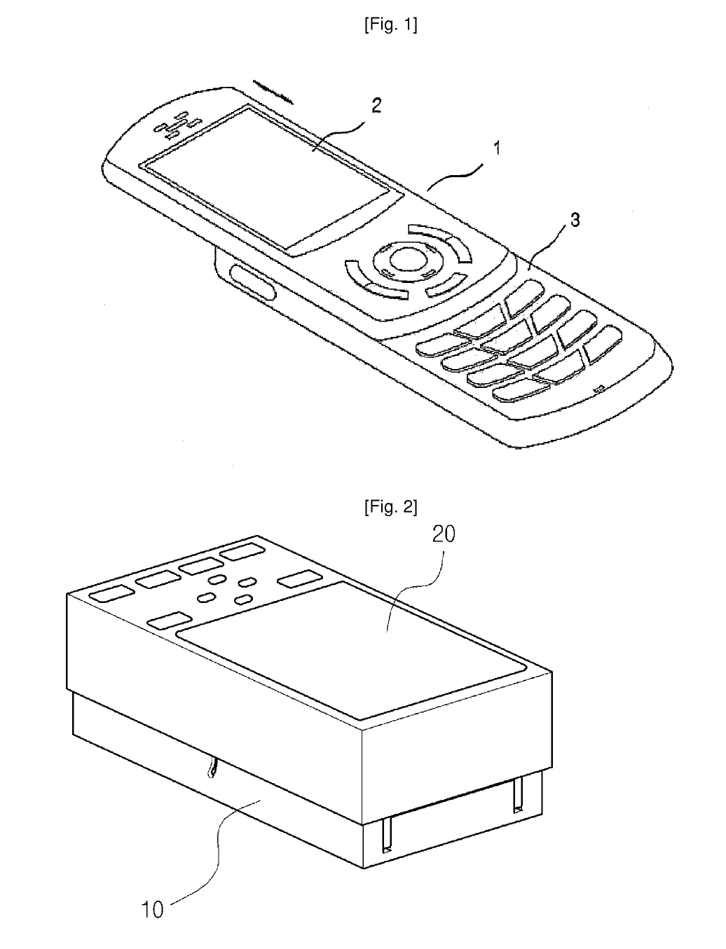

### MODE FOR THE INVENTION

Hereafter, exemplary embodiments of the invention will be explained, with reference to the accompanying drawings.

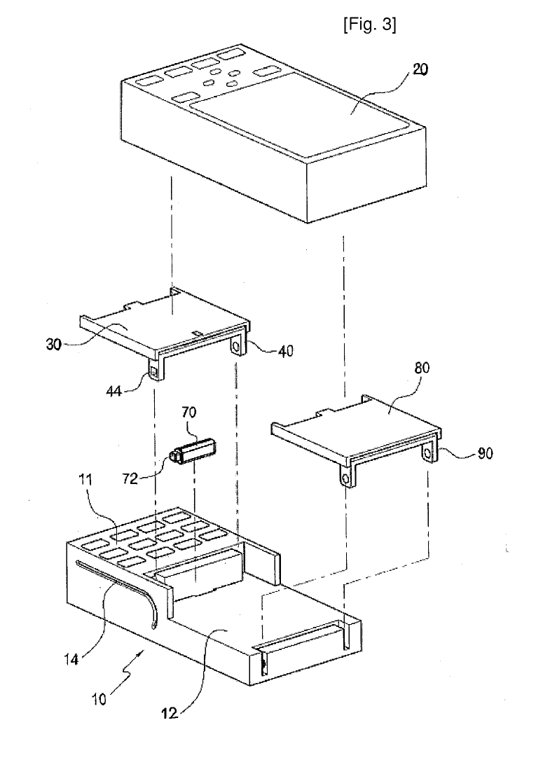

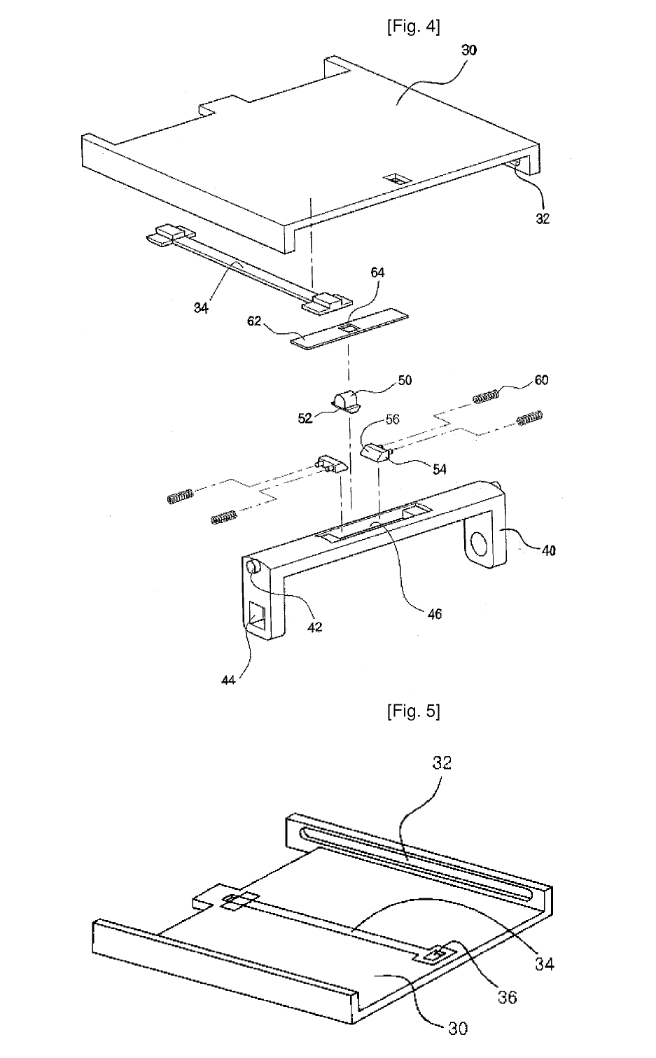

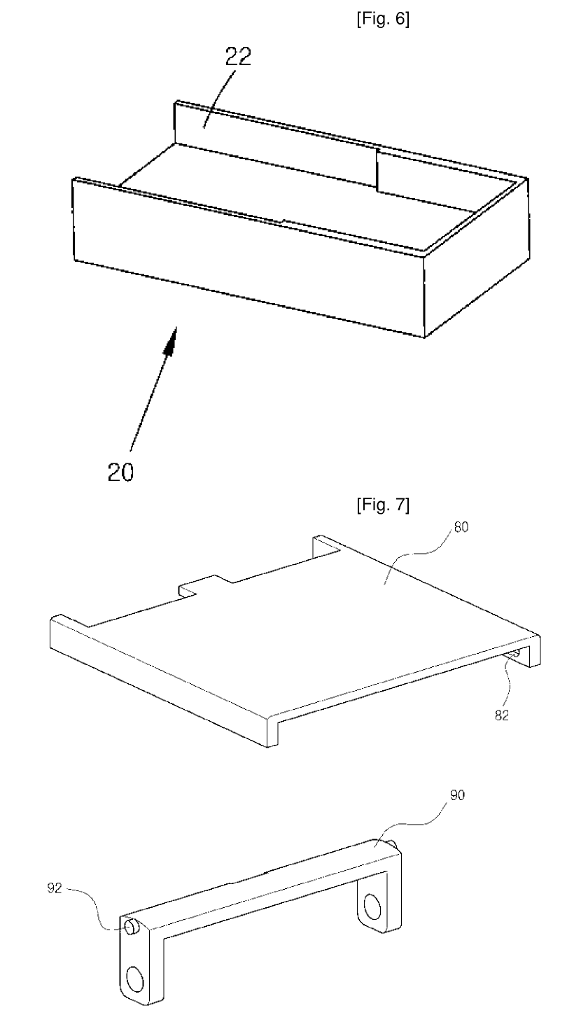

FIG. 2 is a perspective view showing a portable terminal according to an embodiment of the invention. FIG. 3 is an exploded perspective view of the portable terminal of FIG. 2. FIGS. 4 to 7 are exploded perspective view for major components in the portable terminal of FIG. 3.

Referring to FIGS. 2 to 7, the portable terminal of this embodiment includes a main body 10 and a sub-body 20 slidably engaging the main body 10. The main body 10 has a keypad portion 11 on the top face thereof and a stepped-down portion 12 stepwise-lowered from the keypad portion 11. The sub-body 20 is configured so as to move horizontally and then drop down to the stepped-down portion 12 when it is being opened.

Therefore, when the sub-body 20 is closed on the main body 10, the terminal remains in a relatively thick state. When it is opened, however, the sub-body 20 is lowered into the stepped-down portion 12 to thereby reduce the whole thickness for the opened terminal.

Formed in the main body 10 is a first slider groove 14, which is composed of a straight slider groove portion formed along the sliding direction of the sub-body 20 and a curved-down slider groove portion consecutively formed after the straight slider groove portion. Formed in the sub-body 20 is a first slider protrusion 22 formed so as to slidably engage with the first slider groove 14.

A first slider plate 30 and a second slider plate 80 are fixed to the sub-body 20. A first lever 40 is rotatably attached to the main body 10. The first lever 40 allows the first slider plate 30 to slide while the sub-body 20 is departing from the keypad portion 11 of the main body 10, and thereafter rotates by the down movement of the first slider plate 30. In addition to the first lever 40, a second lever 90 is rotatably attached to the main body 10. The second lever 90 allows the second slider plate 80 to slide while the sub-body 20 is departing from the keypad portion 11 and then rotates by the down movement of the second slider plate 80.

The first slider plate 30 is provided with a second slider groove 32 formed horizontally, and the first lever 40 is provided with a second slider protrusion 42 formed so as to be slidably coupled to the second slider groove 32. In addition, the second slider plate 80 is provided with a third slider groove 82 formed horizontally and the second lever 80 is provided with a third slider protrusion 92 formed so as to be slidably coupled to the third slider groove 82.

Formed in the first lever 40 is a space portion 46 for accommodating a resiliently protruding means, and a rail 34 is attached to the first slider plate 30. The rail 34 includes a groove 36 into which the resiliently protruding means is combined. While the first slider plate 30 slides, the rail 34 remains in contact with the resiliently protruding means. Preferably, the rail is formed of a wear-resistant material.

The resiliently protruding means includes a slider cam 54 having a first bevel face 56 and moving in horizontal direction, a lift cam 50 having a second bevel face 52 face-contacting the first bevel face 56 and moving in vertical direction so as to be engaged with and released from the groove 36, and a compression spring 60 for urging the slider cam 54 towards the lift cam 50.

A cover 62 is combined to the space portion 46 of the first lever 40 in order to prevent escaping of the lift cam 50. Formed in the cover 62 is a through-hole 64 through which the lift cam 50 protrudes. A clutch member 70 is installed in the main body 10. The clutch member 70 is configured to generate a resistant force against rotation of the first lever 40 at the initial state and, at the later state, to generate a force urging the rotation of the first lever 40.

The clutch member 70 may employ a cover hinge device disclosed in Korean Patent No. 10-0391379. An angular shaft 72 protrudes externally from the housing of the clutch member 70. Details on the clutch member 70 are omitted.

The housing of the clutch member 70 is fixed to the main body 10 and the protruding angular shaft 72 is coupled with an angular bore 44 of the first lever 40.

Hereafter, operation of the above-configured portable terminal will be explained.

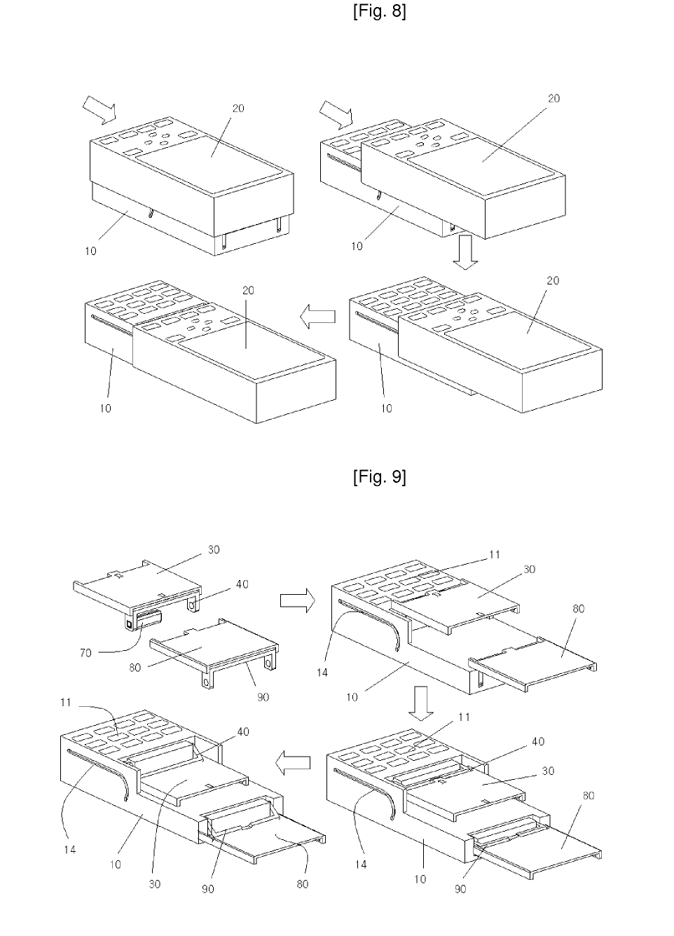

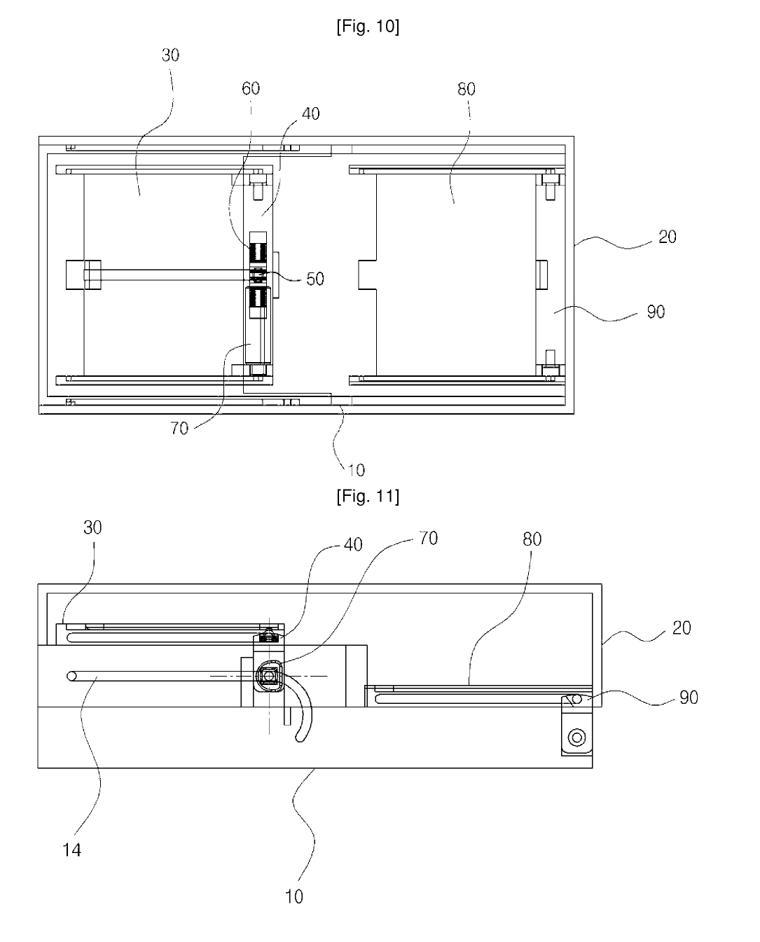

FIGS. 8 and 9 are perspective views showing operations of the portable terminal of FIG. 2. FIG. 10 is a transversal cross-section showing the portable terminal of FIG. 2 when the sub-body is closed. FIG. 11 is a vertical cross-section showing the portable terminal of FIG. 2 when the sub-body is closed.

As shown in the figures, with the sub-body 20 closed on the main body 10, the sub-body 20 closes up to the keypad of the main body 10. The clutch member 70 suppresses rotation of the first lever and the lift cam 50 installed in the first lever 40 is engaged into the groove 36 of the rail 34, which is fixed on the first slider plate 30. Thus, the first slider plate 30 can be held in place, i.e., at the closed state.

The compression spring 60 urges the slider cams 54 such that the first bevel face 56 of the slider cam 54 pushes up the second bevel face 52 of the lift cam 50. Thus, the lift cam 50 is engaged into the groove 36 of the rail 34 to retain the sub-body.

At this state, if the sub-body 20 is pushed down, the first and second slider plates 30 and 80 slide, along with the sub-body 20. Then, the lift cam 50 is released from the groove 36 of the rail 34 and moves along the rail 34.

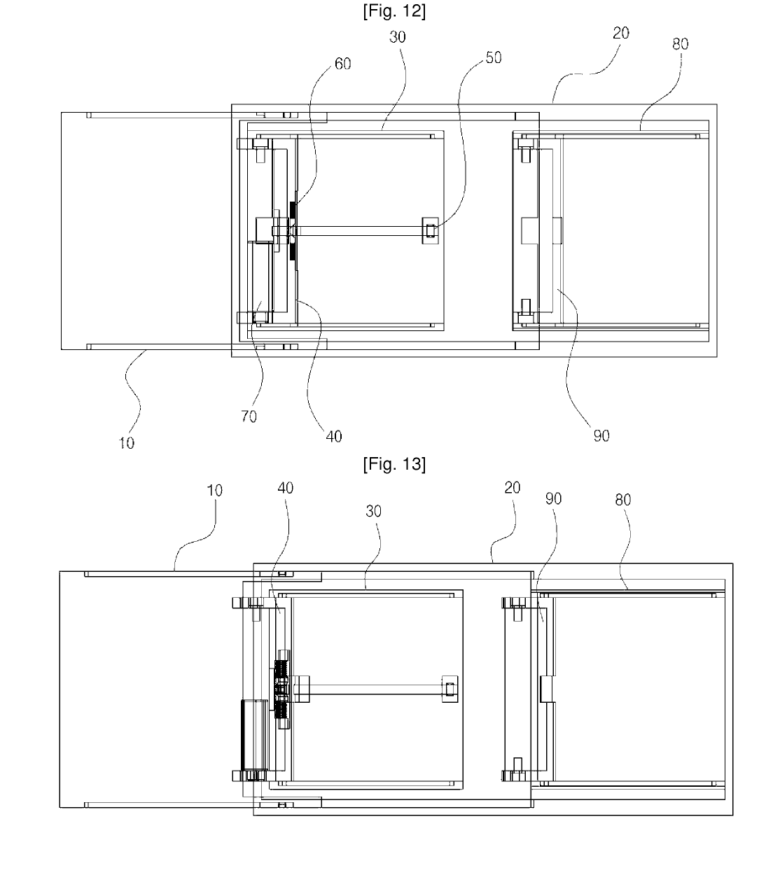

FIG. 12 is a transversal cross-section showing the portable terminal of FIG. 10 when the sub-body is being opened. FIG. 13 is a vertical cross-section showing the portable terminal of FIG. 12 when the sub-body is being opened.

At the initial state of sliding open, the first slider protrusion 22 formed in the sub body 20 travels along the straight portion of the first slider groove 14 formed in the main body 10. As the first slider plate 30 moves, the second slider protrusion 42 of the first lever 40 moves to the end of the second slider groove 32. In addition, as the second slider plate 80 moves, the third slider protrusion 92 of the second lever 90 moves to the end of the third slider groove 82.

Thereafter, the first slider protrusion 22 formed in the sub-body 20 moves down along the curved-down portion of the first slider groove 14. The first and second levers 40 and 90 are rotated by the first slider plate 30 and the second slider plate 80 respectively. Accordingly the sub-body 20 drops down into the stepped-down portion of the main body 10.

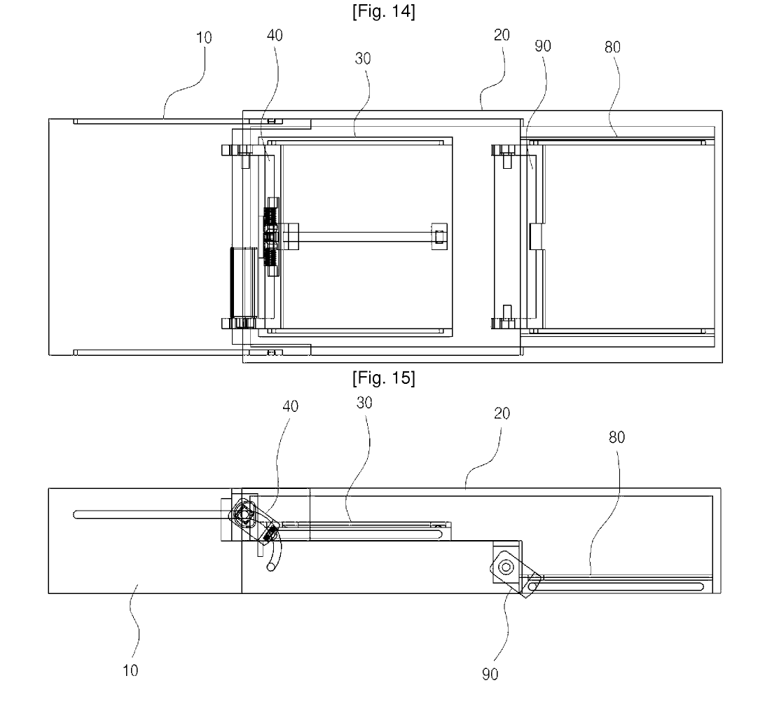

FIG. 14 is a transversal cross-section showing portable terminal of FIG. 12 when the sub-body is completely opened. FIG. 15 is a vertical cross-section showing the portable terminal of FIG. 13 when the sub-body is completed opened.

At the initial state, the clutch member 70 generates a force resistant to rotation of the first lever 40, but after some extent of rotation, the force direction is reversed to urge the rotation of the first lever 40. Detailed operations of the clutch member are disclosed in Korean Patent No. 10-0391379.

If the sub-body 20 is rested on the stepped-down portion 12 of the main body 10, the combined thickness of the sub-body 20 and main body 10 is maximally reduced to provide for user's convenience and wearing comfort. In addition, the shape of the portable terminal is made rectangular to thereby provide for structural stability.

Closing operation of the sub-body 20 on the main body 10 is carried out in reverse orders to the above opening operation.

### INDUSTRIAL APPLICABILITY

As described above, the present invention is applied to a slide-type portable terminal in such a manner that, when the sub-body is opened from the main body, the combined thickness of the terminal can be maximally reduced.

Although the present invention has been described with reference to several exemplary embodiments, the description is illustrative of the invention and is not to be construed as limiting the invention. Various modifications and variations may occur to those skilled in the art, without departing from the spirit and scope of the invention, as defined by the appended claims.

1-6. (canceled)

7. A portable terminal comprising:
a main body;
a sub-body slideable relative to the main body between a first, closed position and at least a second, opened position;
at least one of the main body and the sub-body including a first slider groove having a straight portion and a curved-down portion; and
the other one of the main body and the sub-body including a first slider protrusion slidably engaging the slider groove,
whereby the sub-body drops downwardly relative to the main body while slidably opening with respect to the main body towards the second, opened position, as the first slider protrusion slides along the curved-down portion of the first slider groove in a direction generally away from the straight portion of the first slider groove; and
whereby the sub-body raises upwardly relative to the main body while slidably closing with respect to the main body towards the first, closed position as the first slider protrusion slides along the curved-down portion of the first slider groove in an opposite direction generally towards the straight portion of the first slider groove.

8. The portable terminal as claimed in claim 1, further comprising:
first and second slider plates coupled to the sub-body;
first and second levers rotatably coupled to the main body;
the first lever allowing the first slider plate to slide while the first slider protrusion slides along the straight portion of the first slider groove and rotating by down-movement of the first slider plate while the first slider protrusion slides along the curved-down portion of the first slider groove; and
the second lever allowing the second slider plate to slide while the first slider protrusion slides along the straight portion of the first slider groove and rotating by down-movement of the second slider plate while the first slider protrusion slides along the curved-down portion of the first slider groove.

9. The portable terminal as claimed in claim 8, wherein:
at least one of the first slider plate and the first lever includes a slider protrusion engaged with a slider groove of the other one of the first slider plate and first lever; and
at least one of the second slider plate and the second lever includes a slider protrusion engaged with a slider groove of the other one of the second slider plate and second lever.

10. The portable terminal as claimed in claim 8, wherein:
at least one of the first and second levers includes a resiliently protruding means; and
at least one of the first and second plates includes a groove with which the resiliently protruding means is engaged.

11. The portable terminal as claimed in claim 10, wherein the resiliently protruding means includes:
a slider cam horizontally movable and having a first bevel face;
a lift cam having a second bevel face face-contacting with the first bevel face and vertically movable to be engaged with and released from the groove; and
a compression spring for urging the slider cam towards the lift cam.

12. The portable terminal as claimed in claim 8, wherein the main body includes a clutch member that generates a resistant force against rotation of at least one of the first and second levers at an initial state and that generates a force urging the rotation of the at least one of the first and second levers at a later state.

13. The portable terminal as claimed in claim 7, wherein:
the main body includes the first slider groove; and
the sub-body includes the first slider protrusion.

14. The portable terminal as claimed in claim 7, wherein the curved-down portion of the first slider groove is consecutively formed from the straight portion of the first slider groove.

15. The portable terminal as claimed in claim 7, wherein the curved-down portion of the first slider groove has a general concave curvature relative to the straight portion of the first slider.

16. The portable terminal as claimed in claim 7, wherein the straight portion of the first slider groove is generally parallel with the horizontal sliding direction of the sub-body relative to the main body between the first, closed position and the second, opened position.

17. The portable terminal as claimed in claim 7, wherein:
a top surface of the main body is disposed generally under the sub-body when the sub-body is in the first, closed position; and
the top surface of the main body is generally aligned with a top surface of the main body when the sub-body is in the second, opened position.

18. The portable terminal as claimed in claim 7, further comprising:
a user input device coupled to the main body for common movement therewith;
a display coupled to the sub-body for common movement therewith;
wherein the user input device is disposed generally under and covered by at least a portion of the sub-body when the sub-body is in the first, closed position; and
wherein the display is generally planar with the user input device when the sub-body is in the second, opened position.

19. The portable terminal as claimed in claim 7, wherein:
the main body includes a first, keypad portion and a second, stepped-down portion stepwise-lowered from the first, keypad portion; and
the sub-body is configured so as to drop downwardly into the stepped-down portion of the main body when the sub-body is slidably opening with respect to the main body towards the second, opened position, as the first slider protrusion slides along the curved-down portion of the first slider groove.

20. A portable terminal comprising:
a first body;
a second body slideable relative to the first body between a first, closed position and at least a second, opened position;
a first slider groove having a straight portion and a curved-down portion; and
a first slider protrusion slidably engaged with the first slider groove;
the curved-down portion of the first slider groove configured such that:
the second body moves generally linearly along and downwardly relative to the first body when the second body is slidably moved towards the second, opened position and the first slider protrusion slides along the curved-down portion of the first slider groove; and
the second body moves generally linearly along and upwardly relative to the first body when the second body is slidably moved towards the first, closed position and the first slider protrusion slides along the curved-down portion of the first slider groove.

21. The portable terminal as claimed in claim 20, further comprising:
a user input device coupled to the first body such that the user input device is disposed generally under and covered by at least a portion of the second body when the second body is in the first, closed position; and
a display coupled to the second body such the display and the user input device are generally planar with each other when the second body is in the second, opened position.

22. The portable terminal as claimed in claim 21, wherein the user input device comprises a keypad.

23. The portable terminal as claimed in claim 21, wherein the second body includes an interior for receipt of the user input device when the second body is in the first, closed position.

24. The portable terminal as claimed in claim 20, further comprising:
first and second slider plates coupled to the second body;
first and second levers rotatably coupled to the first body;
the first lever allowing the first slider plate to slide while the first slider protrusion slides along the straight portion of the first slider groove and rotating by down-movement of the first slider plate while the first slider protrusion slides along the curved-down portion of the first slider groove; and
the second lever allowing the second slider plate to slide while the first slider protrusion slides along the straight portion of the first slider groove and rotating by down-movement of the second slider plate while the first slider protrusion slides along the curved-down portion of the first slider groove.

25. The portable terminal as claimed in claim 24, wherein:
at least one of the first slider plate and the first lever includes a slider protrusion engaged with a slider groove of the other one of the first slider plate and first lever; and
at least one of the second slider plate and the second lever includes a slider protrusion engaged with a slider groove of the other one of the second slider plate and second lever.

26. The portable terminal as claimed in claim 24, wherein:
at least one of the first and second levers includes a resiliently protruding means; and
at least one of the first and second plates includes a groove with which the resiliently protruding means is engaged.

27. The portable terminal as claimed in claim 26, wherein the resiliently protruding means includes:
a slider cam horizontally movable and having a first bevel face;
a lift cam having a second bevel face face-contacting with the first bevel face and vertically movable to be engaged with and released from the groove; and
a compression spring for urging the slider cam towards the lift cam.

28. The portable terminal as claimed in claim 24, wherein the first body includes a clutch member that generates a resistant force against rotation of at least one of the first and second levers at an initial state and that generates a force urging the rotation of the at least one of the first and second levers at a later state.

29. The portable terminal as claimed in claim 24, wherein:
the first body includes the first slider groove; and
the second body includes the first slider protrusion.

30. The portable terminal as claimed in claim 20, wherein the curved-down portion of the first slider groove is consecutively formed from the straight portion of the first slider groove.

31. The portable terminal as claimed in claim 20, wherein the curved-down portion of the first slider groove has a general concave curvature relative to the straight portion of the first slider.

32. The portable terminal as claimed in claim 20, wherein the straight portion of the first slider groove is generally parallel with the horizontal sliding direction of the second body relative to the first body between the first, closed position and the second, opened position.

33. The portable terminal as claimed in claim 20, wherein:
a top surface of the first body is disposed generally under the second body when the second body is in the first, closed position; and
the top surface of the first body is generally aligned with a top surface of the first body when the second body is in the second, opened position.

34. The portable terminal as claimed in claim 20, wherein:
the first body includes a first, keypad portion and a second, stepped-down portion stepwise-lowered from the first, keypad portion; and
the second body is configured so as to move downwardly into the stepped-down portion of the first body when the second body is slidably opening with respect to the first body towards the second, opened position, as the first slider protrusion slides along the curved-down portion of the first slider groove.

35. A slider mechanism for a portable terminal having a first body, a second body slideable relative to the first body between a first, closed position and at least a second, opened position, the slider mechanism comprising:
a first slider groove having a straight portion and a curved-down portion with a generally concave curvature relative to the straight portion;
a first slider protrusion slidably engagable with the first slider groove;
the sliding engagement of the first slider protrusion with the curved-down portion of the first slider groove operable for moving the second body upwardly when the second body is slidably moved relative to the first body towards the first, closed position as the first slider protrusion slides along the curved-down portion of the first slider groove, and for moving the first body downwardly when the second body is slidably moved relative to the first body towards the second, open position as the first slider protrusion slides along the curved-down portion of the first slider groove.

36. The slider mechanism as claimed in claim 35, wherein:
the first slider groove is defined by a first body of a portable terminal; and
the second slider protrusion is defined by a second body of a portable terminal.

37. The slider mechanism as claimed in claim 35, further comprising:
first and second slider plates configured to be coupled to the second body;
first and second levers configured to be rotatably coupled to the first body;
the first lever allowing the first slider plate to slide while the first slider protrusion slides along the straight portion of the first slider groove and rotating by down-movement of the first slider plate while the first slider protrusion slides along the curved-down portion of the first slider groove; and
the second lever allowing the second slider plate to slide while the first slider protrusion slides along the straight portion of the first slider groove and rotating by down-movement of the second slider plate while the first slider protrusion slides along the curved-down portion of the first slider groove.

38. The slider mechanism as claimed in claim 37, wherein:
at least one of the first slider plate and the first lever includes a slider protrusion engagable with a slider groove of the other one of the first slider plate and first lever; and
at least one of the second slider plate and the second lever includes a slider protrusion engaged with a slider groove of the other one of the second slider plate and second lever.

39. The slider mechanism as claimed in claim 37, wherein:
at least one of the first and second levers includes a resiliently protruding means; and
at least one of the first and second plates includes a groove with which the resiliently protruding means is engaged.

40. The slider mechanism as claimed in claim 39, wherein the resiliently protruding means includes:
a slider cam horizontally movable and having a first bevel face;
a lift cam having a second bevel face face-contacting with the first bevel face and vertically movable to be engaged with and released from the groove; and
a compression spring for urging the slider cam towards the lift cam.

41. The slider mechanism as claimed in claim 37, further comprising a clutch member that generates a resistant force against rotation of at least one of the first and second levers at an initial state and that generates a force urging the rotation of the at least one of the first and second levers at a later state.

42. The slider mechanism as claimed in claim 35, wherein the curved-down portion of the first slider groove is consecutively formed from the straight portion of the first slider groove.

43. The slider mechanism as claimed in claim 35, wherein the curved-down portion of the first slider groove is shaped as the English Alphabetic Letter C.

44. A cellular phone comprising the slider mechanism of claim 35.
